(19) United States
(12) Patent Application Publication
(10) Pub. No.: US 2019/0105735 A1
(43) Pub. Date: Apr. 11, 2019

(54) METHOD FOR PRODUCING A WORKPIECE BY COATING AND ADDITIVE MANUFACTURING; CORRESPONDING WORKPIECE

(71) Applicant: Siemens Aktiengesellschaft, Munich (DE)

(72) Inventors: Christian Brunhuber, Auerbach (DE); Andreas Graichen, Norrköping (SE); Henning Hanebuth, Pliening OT Gelting (DE); Heinz-Ingo Schneider, Baldham (DE)

(73) Assignee: Siemens Aktiengesellschaft, Munich (DE)

(21) Appl. No.: 16/089,601

(22) PCT Filed: Feb. 10, 2017
(86) PCT No.: PCT/EP2017/052959

§ 371 Date: Sep. 28, 2018

(30) Foreign Application Priority Data
Apr. 8, 2016 (EP) 16164438.0

(51) Int. Cl. B23K 26/342; B33Y 10/00; B33Y 40/00; B33Y 70/00; B23K 26/00

(52) U.S. Cl. CPC B23K 26/342; B33Y 10/00; C23C 4/129; B33Y 70/00; B23K 26/0006; B33Y 40/00

(57) ABSTRACT

A method for producing a workpiece, includes providing a substrate having a predetermined surface structure; coating the surface structure with a coating material, wherein the coating material is resistant to a production temperature of an additive production method; the additive production of a material for the workpiece on the coated surface structure using the additive production method such that the coated surface structure defines a base surface of the workpiece to be produced, and the detachment of the substrate. A workpiece is produced by the described method.

### CROSS REFERENCE TO RELATED APPLICATIONS

This application is the US National Stage of International Application No. PCT/EP2017/052959 filed Feb. 10, 2017, and claims the benefit thereof. The International Application claims the benefit of European Application No. EP16164438 filed Apr. 8, 2016. All of the applications are incorporated by reference herein in their entirety.

### FIELD OF INVENTION

The present invention relates to a method for producing a workpiece, for example a high-temperature-resistant workpiece, such as a workpiece or component that is used in the hot gas path of a turbomachine, for example a gas turbine. The present invention also relates to a workpiece that has been produced or can be produced by said method.

### BACKGROUND OF INVENTION

Additive or generative manufacturing processes (“rapid prototyping”) for producing three-dimensional (3D) structures, such as for example selective laser melting (SLM) and deposition welding, for example laser deposition welding (“laser cladding” or LMD for “laser metal deposition”) are used for example in the production and repair of parts of gas turbines that are subjected to hot gas or are exposed to high temperatures.

The SLM method allows the additive build-up of complexly shaped structures or workpieces with a relatively fine internal structure, for example with finenesses or structure sizes of between 80 μm and 100 μm or less. The SLM method is among the powder-bed processes, where a reduction of the structure sizes or improvement of the surface roughness can be achieved primarily by a reduction of the powder fractions down to an average powder grain size of about 20 to 40 μm. Still smaller powder grains are generally no longer conveyable and/or usable. An achievable surface roughness of surfaces produced by means of SLM methods lies approximately between 60 μm and 100 μm. The SLM method also allows building-up rates or depositing rates of 3 to 8 cm³/h.

In the case of the SLM method, the build-up of a structure is defined along just one specific (building-up) axis. Therefore, when building up inner-lying or hollow structures, it is necessary to rely on supporting structures, which for example support overhanging portions of the structures during production, and possibly allow a corresponding dissipation of heat. The supporting structures however require unnecessary deposition material and, what is more, also must subsequently be laboriously separated from the actually desired structure and/or subsequently be machined correspondingly. The supporting structures are usually chosen and arranged so as to avoid particularly undesired artefacts that are caused by additive manufacturing. As a further disadvantage of the SLM method, when performing a subsequent operation of clearing away excess starting material, in particular powdered material, it is only possible with difficulty to remove such material from filigree spaces of the component.

By contrast with the SLM method, in the case of the LMD process the additive build-up can take place along at least three axes (for example three spatial directions perpendicular to one another). In the case of the LMD method, it is alternatively possible to use five-axis or eight-axis devices, in which for example a base or underlying surface for the material to be built up and a deposition or production head or the corresponding powder nozzle or laser device are movable in three spatial directions that are perpendicular to one another. For an eight-axis device, that is to say with eight geometrical degrees of freedom, the underlying surface may be additionally movable about two different axes (rotational and/or tilting axes).

The LMD method is usually a CAD (“computer-aided design”) and/or robot-assisted method, it being possible for 3D structures to be built up or produced almost isotropically. The LMD method allows building-up or depositing rates of 30 to 40 cm³/h. One disadvantage of the LMD method concerns the difficulty in producing internal structures or inner-lying structures or geometries with structure sizes or structure dimensions of less than 150 μm, as a result of which additive manufacturing has limits in this respect.

In particular in the production of components for turbomachines, for example gas turbines, internal structures with structure sizes of in some cases well below 100 μm or 150 μm may be desired or required for a large number of possible components for various applications. Such structures can currently only be produced by means of time-consuming and costly casting technology.

Deposition welding methods are known for example from EP 2 756 909 A1.

### SUMMARY OF INVENTION

Therefore, an object of the present invention is to provide an improved method for producing a workpiece or a component, in particular a method with which components can be produced more cost-efficiently and/or time-efficiently and/or with improved properties.

This object is achieved by the features of the independent patent claims. Advantageous refinements are the subject of the dependent patent claims.

One aspect of the present invention relates to a method for producing a workpiece, comprising providing a substrate having a predetermined surface structure.

The workpiece is advantageously a high-temperature-resistant component for use in the hot gas path of a turbomachine, for example a gas turbine for energy generation.

The predetermined surface structure is advantageously a microscopic surface structure. In other words, the predetermined surface structure advantageously has at least one microscopic surface structure element. The surface structure is also predetermined, i.e. defined for example with respect to its topography or structure for a specific application.

The method also comprises the coating of the surface structure with a coating material, advantageously a metal, the coating material being resistant to a production temperature of an additive manufacturing process.

The production temperature is advantageously a temperature that is reached by a fusing device of the corresponding additive manufacturing process, in particular a laser beam or electron beam, or to which a material is heated within an extremely short time as soon as it is hit or impinged upon by said beam.

By the coating material or by the corresponding coating step within the manufacturing process, it is possible in particular for the substrate to be protected by the protective coating of the coating material from the effect of high temperatures during the additive manufacturing, as described above, in particular from an input of heat or damage caused as a result.

In a refinement, the method for coating the surface structure is adapted with respect to the production temperature to the additive manufacturing process (or vice versa) in such a way that the coating material is resistant to the production temperature.

The method also comprises the additive manufacturing of a material for the workpiece or the component on the coated surface structure by the additive manufacturing process, so that the coated surface structure defines a base surface of the workpiece to be produced.

The base surface is advantageously the surface of an underside of the workpiece of which the structure is advantageously first built up or deposited during the production. In this sense, the substrate is advantageously determinative for the form of the workpiece or the component, it being possible for the structure of the substrate to be transferred to the base surface of the workpiece to be produced or the structure is replicated on it by the method according to the invention. In this sense, the base surface of the workpiece may for example comprise or form a negative or positive of the predetermined surface structure. Preferably, the surface structure forms the corresponding negative, or represents it, and the base surface forms the corresponding positive, or represents it. In other words, the base surface also represents an imprint of the surface structure of the substrate, defines it or comprises said imprint. In this connection, according to the present disclosure, the workpiece may likewise have a (replicated) surface structure.

The method also comprises—after the additive manufacturing—the detachment of the substrate from the coating material or the workpiece, for example by means of an acid treatment or other methods of the prior art.

In a refinement, a substrate material of the substrate has been or is chosen in such a way that the substrate can subsequently be detached or separated from the workpiece in a particularly easy way by thermal or chemical means.

The described method may comprise further method steps, for example a thermal treatment after the additive manufacturing of the material, where in particular a crystal structure or material phase that is favorable or required for the workpiece is set. In this case, crystal defects in the material can be healed and/or internal stresses in the material can be reduced.

As an advantage of the described method, it is possible according to the present invention to produce on the base surface internal structures, or corresponding dimensions of the internal structures, that cannot for example be achieved exclusively by way of conventional LMD technology, i.e. without the definition according to the invention of the base surface. This is achieved in particular by the predetermined surface structure defining by the described method the base surface for the workpiece to be produced by way of the coated substrate.

By the coating of the surface structure with the coating material, it is possible for the advantages mentioned to be used specifically for additive manufacturing processes, that is to say those in which particularly high temperatures are involved.

After providing the substrate having the predetermined surface structure, it is possible in particular for any desired 3D workpiece or component to be produced in any way desired, for example by means of deposition welding, with the base surface defined by the coated surface structure. In particular, it is possible in this case to dispense with the time-consuming production of casting cores or components by conventional casting technology, whereby it is often possible to prevent months of development effort, in particular when molding complex, microscopic internal structures. In turn, the aforementioned advantages of the deposition welding methods can be utilized.

The additive manufacturing is carried out by means of deposition welding, advantageously laser deposition welding, in particular laser powder-deposition welding or electron-beam welding.

In a refinement, in the additive manufacturing of the material for the workpiece, in particular by laser deposition welding, the exposure time, the laser power and/or further parameters are set in accordance with the desired surface structure of the workpiece. In this case it is possible for example for the grain orientation or grain size of the material that is to be built up for the workpiece to be set or influenced, whereby for example the creep resistance of the material or the crack resistance or ductility can be optimized. Alternatively or additionally, bonding defects, for example with respect to cohesion or adhesion of the materials involved, can be prevented by said refinement.

In a refinement, the base surface is a surface that is at least partially inwardly directed or inner-lying or arranged on the inside with respect to a contour of the workpiece to be produced. In other words, the base surface advantageously lies within said contour. The contour in this sense advantageously describes an enveloping surface of the workpiece or component.

In a refinement, the provision of the substrate takes place in such a way that the surface structure has for the definition of the base surface at least one surface structure element, advantageously a multiplicity of surface structure elements, with a dimension of (in each case) less than 100 μm.

An advantage of the described method as provided by the invention concerns an improved “resolution” of structures or features on the base surface, or increased production accuracy. It is also possible to dispense with complex supporting structures.

It is in particular possible to produce microstructures, such as for example rib structures and/or turbulators for an application of the workpiece in turbine blades, with individual structure sizes of a few millimeters, or even down to sizes of less than 100 μm, for example on the inner side of difficultly accessible components or workpieces, that cannot be achieved by either powder-bed processes, for example SLM technology, or milling technology—because the milling tool cannot gain access to said inner side due to the size of the milling heads.

In a refinement, the material for the workpiece is a nickel-based or cobalt-based superalloy or a starting material therefor.

In a refinement, the material for the workpiece comprises a nickel-based or cobalt-based superalloy or a starting material therefor.

These refinements are expedient in particular for the use of the workpiece or component in the area of turbomachines.

In a refinement, the workpiece is a high-temperature-resistant component, for example a component that is used in, or in connection with, the hot gas path of a turbomachine, such as a gas turbine. High-temperature-resistant may mean in particular that the workpiece or component or its material is highly heat resistant, has a melting point of over 1000° C., advantageously 1200° C., and/or for example achieves operating temperatures of 80%, 90% or more of the melting point of the corresponding material.

In a refinement, the surface structure is roughened or pretreated—advantageously only superficially—before the coating with the coating material, in order to improve an adhesive bond of the coating material on the surface structure. Said roughening or pretreatment is advantageous in particular for imparting an adhesive bond between the coating material and the surface structure. Furthermore, this treatment may be performed by physical or chemical means known to a person skilled in the art, for example etching or an ozone treatment.

In a refinement, the coating material is a metal and/or a ceramic-metal composite, for example a “CERMET” material.

In a refinement, the coating material and the material for the workpiece are identical, at least in constituent parts. The coating material and the material for the workpiece may be completely identical. This has the advantage in particular that no undesired chemical or physical reactions occur between the coating material and the material for the workpiece.

In a refinement, the coating material and the material for the workpiece are as similar as possible with regard to the respective chemical and/or physical properties.

The coating of the surface structure is performed by a thermal coating method, for example thermal spraying. The advantage of these methods is that usually good homogeneity of the layer to be deposited and an advantageously small porosity and/or a good bonding on the surface structure can be achieved.

In a refinement, the coating is performed by means of an isotropic coating method, in particular a method of chemical vapor deposition. This refinement advantageously allows even difficultly accessible, for example inner-lying, surfaces to be coated with the coating material, and consequently the advantages according to the invention to be used.

In a refinement, after the provision of the substrate, and advantageously before the coating of the surface structure with the coating material, a (separate) adhesion-promoting layer is applied to the surface structure. Preferably, this adhesion promoter is as thin as possible, in order not to impair the resolution of the surface structures that are to be transferred to the workpiece.

In a refinement, the coated surface structure has a roughness of less than 60 μm, advantageously less than 40 μm, particularly advantageously less than 30 or 20 μm. This refinement allows in particular a fine or high “resolution” of the coated surface structure to be achieved, and consequently correspondingly filigree surface structures to be replicated for the workpiece.

In a refinement, the coating of the surface structure is carried out so uniformly or homogeneously that, advantageously over the entire surface area of the surface structure, a layer thickness of the coating material deviates for example from a mean value by less than 100 μm, advantageously less than 50 μm.

In a refinement, the substrate comprises a ceramic or a casting component that forms the surface structure.

A further aspect of the present invention relates to a workpiece or component that has been produced or can be produced by the method described here, for example a workpiece comprising the base surface, the production method for the workpiece comprising the additive manufacturing of the material for the workpiece on the predetermined surface structure of the substrate and the surface structure—as described—defining the base surface. In other words, the (coated) base surface comprises an imprint of the surface structure or part of the surface structure.

According to the described production method, the described workpiece advantageously has specific and/or characteristic properties. For example, with regard to the properties of its structure or surface, the material or workpiece can be distinguished from workpieces that have been or can be produced by means of other methods by relevant methods of surface analysis or structure analysis. Such methods are for example transmission electron microscopy (TEM), energy-dispersive x-ray analysis and/or x-ray fluorescence analysis. By these methods it is possible in particular to investigate the crystal structure of the corresponding material, and carry out an element analysis.

Features that relate here to the method can likewise relate to the workpiece, and vice versa.

### BRIEF DESCRIPTION OF THE DRAWINGS

Further details of the invention are described below on the basis of the drawing. The same or corresponding elements of the drawing are respectively provided with the same designations in the individual figures.

FIG. 1 schematically indicates the sequence of a method for producing a workpiece.

FIG. 2 schematically shows a workpiece that has been produced by means of the method indicated in FIG. 1.

FIG. 3 schematically shows the workpiece from FIG. 2, a substrate having been detached.

### DETAILED DESCRIPTION OF INVENTION

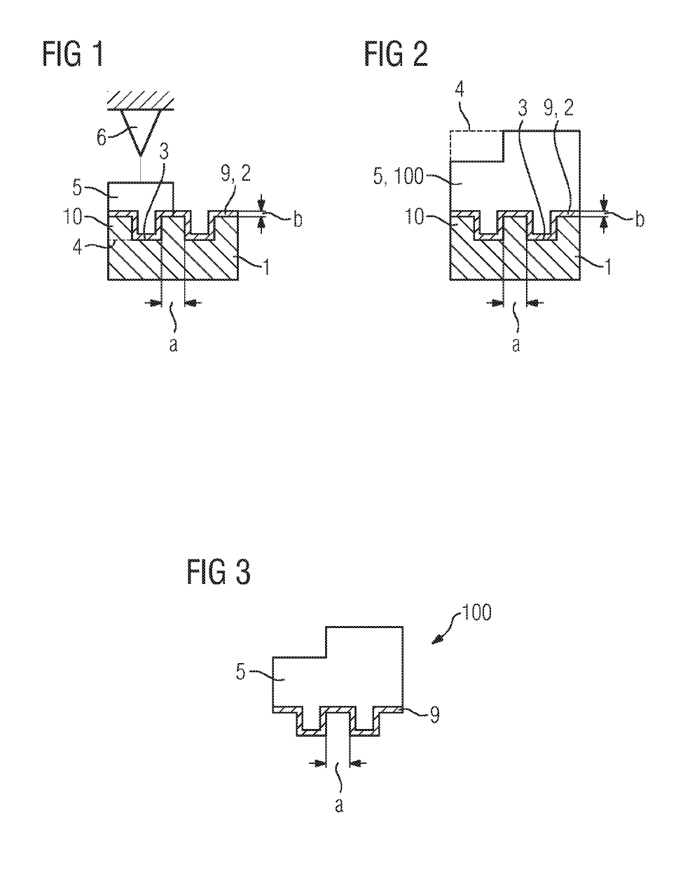

FIG. 1 schematically shows the sequence of a method for the additive manufacturing of a workpiece or component (compare designation 100 in FIG. 2), for example a component for a turbomachine, such as a gas turbine. The workpiece 100 is advantageously a high-temperature-resistant workpiece that is used in connection with a hot air path of a gas turbine. The workpiece advantageously consists of a nickel-based or cobalt-based superalloy or comprises a corresponding material.

The method comprises the provision of a substrate 1, which in FIG. 1 and FIG. 2 is indicated in a side view or sectional view. The substrate 1 comprises a predetermined surface structure 2. The predetermined surface structure 2 may be for example a rib structure and/or a turbulator structure or be defined thereby.

The predetermined surface structure 2 is advantageously a surface structure with surface structure elements 10, as shown in FIGS. 1 and 2. The surface structure elements 10 have (shown by way of example) in each case a rectangular cross section.

The surface structure elements 10, advantageously each individual or at least one of the surface structure elements 10, may have an outer dimension of some or a few millimeters, for example up to 3 millimeters. Alternatively, the surface structure elements 10 may have a dimension in the micrometer range, advantageously less than 100 μm, particularly advantageously less than 80 μm or still smaller (compare dimension a further below).

The surface structure 2 is advantageously predetermined or defined for the production of the workpiece. In other words, the topography of the surface structure is defined.

Although not explicitly shown in the figures, the surface structure elements or else only some of them may be different and/or have dimensions that are different from one another.

The method also comprises the coating of the surface structure 2 with a coating material 9. In FIG. 1, the coating material 9 is shown already deposited completely on the surface structure 2 by the method according to the invention for producing the workpiece. The coating material 9 has also been applied to the surface structure with a layer thickness b, to be precise in such a way that the coated surface structure 2 defines a base surface 3 of the workpiece 100 (to be produced). This is indicated in FIG. 1 by showing that the surface structure 2 forms a negative and the base surface 3 or its surface structure (not explicitly depicted) forms a corresponding positive. In other words, the surface structure 2 (coated with the coating material) of the substrate 1 is determinative for the form of the base surface of the workpiece 100. The finished workpiece (compare FIGS. 2 and 3) accordingly has the base surface 3.

The coating material 9 is also advantageously chosen and/or formed in such a way that it is resistant, at least for a short time, to a production temperature of the additive manufacturing process with which the workpiece is produced (cf. further below). In particular, the coating material 9 is resistant to and/or thermally stable at temperatures above 1000° C., advantageously above 1200° C., 1400° C. or still higher temperatures; at least for a period of several seconds or minutes, during which the coating material is for example exposed directly to a laser beam or electron beam.

The coating with the coating material 9 is advantageously performed within the scope of the method according to the invention in such a way that the coating material 9 is coated or deposited on the surface structure 2 of the substrate 1 with a layer thickness of b, particularly advantageously by means of a thermal coating process. Preferably, other methods, in particular methods of physical vapor deposition, for example electron-beam evaporation or pulsed laser deposition, may be used for the coating. Other possible methods are thermal spraying, for example high-speed flame spraying, or else cold-gas spraying, a dip coating method or a galvanic coating method.

The coating material 9 is advantageously a metal or a ceramic-metal composite, for example a ceramic compound in a metal matrix, such as a “CERMET” material.

Accordingly, thermal coating methods, such as thermal spraying, are used particularly advantageously for the coating. Alternatively, however—advantageously in the case of low-melting substrate materials, i.e. structures that have the surface structure such as polymers or low-melting metals—“cold” coating methods may be used for the coating of the surface structure.

Although not explicitly shown in the figures, an adhesion promoter for improving the adhesive bond of the coating material 9 may be applied before the coating of the surface structure 2 with the coating material 9.

Particularly advantageously, the coating material 9 is also applied in such a way that it is arranged as far as possible, advantageously completely, uniformly and/or homogeneously on the surface structure 2. Particularly advantageously, likewise on vertical or inclined portions of the surface structure, the layer thickness of the coating material 9 is likewise b.

Preferably, the coating material 9 is of a material that is chemically and/or physically related to the material from which the workpiece 100 is produced.

Particularly advantageously, the coating material 9 is also of the same material as the workpiece 100, for example a nickel-based or cobalt-based superalloy.

The method also comprises the additive manufacturing of a material 5 for the workpiece on the surface structure 2.

The coating material 9 and the material 5 for the workpiece 100 are advantageously identical, at least in part, for example main constituent parts and/or alloying constituents. The coating material 9 may also be completely identical to the material 5.

In FIG. 1, the workpiece (compare designation 100 in the figure) has not yet been produced completely. Therefore, reference can be made hereafter to the material 5 as synonymous to the workpiece 100. The material may in particular be a starting material for the workpiece.

Furthermore, the method for producing the workpiece may comprise one or more heat treatments, for example for setting certain phase precipitates. These may be in particular expedient phase precipitates or settings of the γ or γ′ phases of the respective material to be produced of the superalloy.

The additive manufacturing of the workpiece is advantageously performed by means of deposition welding, for example laser deposition welding (LMD), in particular laser powder-deposition welding or electron-beam welding. Said methods or techniques for deposition welding are advantageously performed in a CAD-aided and/or robot-assisted manner or can be correspondingly controlled. A corresponding laser deposition welding device is indicated in FIG. 1 by the designation 6.

The material 5 for producing the workpiece 100 is advantageously produced or manufactured according to the described method by laser powder-deposition welding. In this case, within the described method for producing the workpiece, it is advantageously produced in accordance with the material properties that are expedient for the desired (3D) structure. This may involve setting process parameters, such as the laser power, the time of exposure to the laser or other parameters in accordance with the desired material phase. Furthermore, a longer exposure time may be required for example at difficultly accessible locations or edges of the workpiece to be produced than at other locations. It is also possible when “scanning” during the material build-up for an apparatus head of the deposition welding device to be guided by way of or with the aid of a feedback loop.

FIG. 2 shows inter alia the completely produced workpiece or component 100 that has been produced can be produced by means of the described method. The workpiece 100 is connected in one piece to the substrate 1 by way of the coating material 9 and optionally by way of an adhesion-promoting material. Accordingly, the base surface 3 of the coating material 9 represents or comprises an imprint of the coated surface structure 2. Advantageously, by the described method—by prescribing the surface structure on the substrate—the base surface of the coating material 9, but advantageously also the workpiece 100 to be produced, is defined, replicated or molded, in order to transfer the surface structure onto the workpiece, and consequently to create a particularly high-resolution and/or microscopically structured base surface of the workpiece.

The workpiece 100 in FIG. 2 has a contour 4, which encloses or envelops the workpiece 100 including its surface structure elements. The contour 4 is shown in FIG. 2 by the dashed line and is also shown in FIG. 1 in conjunction with the material 5. With respect to the contour 4 of the workpiece 100 to be produced, the base surface 3 is an at least partially inner-lying surface of the workpiece 100.

The surface structure elements 10 shown in FIGS. 1 and 2, or at least one of them, has/have for example a dimension a of less than 100 μm. The dimension advantageously relates to a width (compare the horizontal direction in FIGS. 1 and 2) of the respective surface structure elements 10, but may also relate to a corresponding depth or height. The width may accordingly refer to a direction along the contour.

Therefore, the smaller the width or dimension a of the surface structure elements 10 of the substrate 1, the smaller, finer or more filigree the base surface 3 of the workpiece can also be structured.

According to one embodiment of the present invention, the substrate 1 is a ceramic or a casting component or comprises for example a ceramic at least on the surface structure 2. The substrate 1 may for example be produced or provided by precision casting with the aid of ceramic casting cores. Preferably, the surface structure 2 has been or is formed by a ceramic casting core. The casting core consists for example of alumina, for example Al₂O₃, or silica (SiO₂) or comprises one of these materials. In other words, the provision of the substrate is carried out according to the described method.

Furthermore, the casting core advantageously has on the outer side a very fine powder grain size, in order to be expediently able to “resolve” a fine, for example microscopically small, surface structure. With increasing distance from the surface structure, the material of the substrate (of the casting core) may comprise an ever more porous or coarser grain size or grading, in order at the same time also to have a sufficient (thermal) shock resistance. Such a graded component advantageously has a particularly small and technologically desired surface roughness of merely 50 μm or less, for example 30 μm.

The term “roughness” may be an average roughness, a root-mean-square roughness or a mean roughness value.

According to a refinement, the substrate comprises at least on the surface structure or as the surface structure 2 a refractory metal, for example tantalum, zirconium, molybdenum or tungsten or some other high-melting, for example base, metal of the fourth, fifth or sixth auxiliary group of the periodic system. According to this refinement, the surface structure has been or is advantageously produced by electron-beam melting.

Although not explicitly shown in the figures, the method also comprises the detachment of the substrate 1 from the workpiece 100 after the additive manufacturing of the same (cf. FIG. 3). For all of the embodiments described, the detachment of the substrate 1 may be performed selectively by thermal or chemical means. For example, irrespective of whether the substrate or the surface structure is metallic or ceramic, the workpiece 100 can be chemically detached.

For example, in the case of a substrate with an aluminum surface structure, the detachment may be performed by means of concentrated hydrochloric acid and at temperatures between 50° C. and 80° C.

FIG. 3 schematically indicates that the substrate 1 has been removed for example by chemical or thermal detachment after the additive manufacturing of the workpiece 100.

As an alternative to the representation of FIG. 3, the substrate may likewise be detached from the workpiece 100 by the coating material 9 being separated from the substrate 1 by suitable means (selective thermal and/or chemical detachment).

The invention is not restricted to the exemplary embodiments by being described with reference to them, but in particular comprises any combination of features in the patent claims, even if this feature or this combination is not itself explicitly specified in the patent claims or exemplary embodiments.

1.-10. (canceled)

11. A method for producing a workpiece, comprising:
providing a substrate having a predetermined surface structure,
coating the surface structure with a coating material by a thermal coating method, the coating material being resistant to a production temperature of an additive manufacturing process,
additively manufacturing a material for the workpiece on the coated surface structure by deposition welding, so that the coated surface structure defines a base surface of the workpiece to be produced, the material being a nickel-based or cobalt-based superalloy or a starting material therefor, and
detaching the substrate in such a way that the structure of the substrate is transferred to the base surface of the workpiece to be produced.

12. The method as claimed in claim 11,
wherein the base surface is a surface of the workpiece that is at least partially inner-lying with respect to a contour of the workpiece to be produced.

13. The method as claimed in claim 11,
wherein the surface structure is roughened or pretreated before the coating with the coating material, in order to improve an adhesive bond of the coating material on the surface structure.

14. The method as claimed in claim 11,
wherein the coating material is a metal and/or a ceramic-metal composite.

15. The method as claimed in claim 11,
wherein the workpiece is a high-temperature-resistant component.

16. The method as claimed in claim 11,
wherein the coating material and the material for the workpiece are identical, at least in constituent parts.

17. The method as claimed in claim 11,
wherein the coated surface structure has a roughness of less than 60 μm.

18. The method as claimed in claim 11,
wherein the substrate comprises a ceramic that forms the surface structure.

19. A workpiece produced by the method according to claim 11,
wherein the material of the workpiece is a nickel-based or cobalt-based superalloy or a starting material therefor.

20. The method as claimed in claim 11,
wherein the thermal coating method comprises thermal spraying.
